(19) United States
(12) Patent Application Publication
(10) Pub. No.: US 2014/0211249 A1
(43) Pub. Date: Jul. 31, 2014

(54) METHOD FOR DETECTING AND TRANSMITTING PROCESS-CONTROL DATA BEFORE AND/OR DURING A PRINTING OPERATION FOR THE PRODUCTION OF PRINTED PRODUCTS IN A PRINTING PRESS

(71) Applicant: Mueller Martini Holding AG, Hergiswil (CH)

(72) Inventors: Markus Bracher, Pfaffnau (CH); André Schenker, Luzern (CH); Peter Kuenzli, Sempach (CH)

(73) Assignee: Mueller Martini Holding AG, Hergiswil (CH)

(21) Appl. No.: 14/163,548

(22) Filed: Jan. 24, 2014

(30) Foreign Application Priority Data
Jan. 25, 2013 (CH) 00314/13

(51) Int. Cl. H04N 1/00

(52) U.S. Cl. CPC H04N 1/0083
USPC 358/1.15

(57) ABSTRACT

With a method for transmitting process-control data before and/or during a printing process for the production of printed products in a printing press, the data are detected at least with the aid of at least one print mark that is effectively connected to a printed product. The data obtained from the print mark are transmitted and/or transferred to at least one processing unit that is arranged downstream of the printing operation. Within the printing process, the data obtained from the print mark are subjected continuously to at least one redundant check in at least one downstream-arranged processing unit, with respect to the data determined during the integral printing process and/or with respect to a further processing location for the printed products which is specified ahead of time.

### CROSS REFERENCE TO RELATED APPLICATIONS

This application claims priority to Swiss Patent Application No. 00314/13, filed Jan. 25, 2013, which is hereby incorporated herein by reference in its entirety.

### TECHNICAL FIELD

A method for detecting and transmitting process-control data before and/or during a printing operation for producing printed products in a printing press.

### BACKGROUND

Specifying data for a point in time before the actual printing process takes place per se precludes the further transmitting of information concerning the success or the quality of the printing process. For example, if a barcode is inserted to communicate the order number to the further processing location, this barcode is inserted into the image either during the imposition or during the raster image process. The barcode is then transferred to the paper during the printing process. In the event that interference occurs during the printing process, for example as a result of a stop command, the barcode can no longer be changed. The further processing equipment will read in the bar code, but it cannot determine whether the printing quality of the respective printed sheet is good.

The following examples are provided for the illustration:

Data is transmitted via a barcode that is affixed to the center of the printed sheet. The printing press is stopped abruptly because of an internal error. One of the two following situations then occurs on a random basis which is based on the point in time for the stop:

The stop is before the barcode or during the reading of the barcode. The further processing equipment cannot read in the barcode. The respective printed sheet cannot be detected and/or allocated and is discharged. The end product is consequently removed even though it is free of defects.

The stop position is after the barcode. The further processing equipment can read in the barcode. The respective printed sheet is detected and/or allocated correctly. The printed sheet ends up as good-quality sheet in the end product with the result that the end product is no longer free of defects.

The printing on of specific marks which are again read in by the further processing equipment is also widely used. The control unit for a cross-cutter, for example, traditionally operates with the aid of cutting marks while a book separation occurs with the aid of separating marks. The simplicity of this solution is advantageous since only positions and, if applicable, also release zones need to be defined. (Concerning the codified print marks, please see the EP2481585 A1.) The extremely restricted function options are a disadvantage (binary information: mark is there or is not there).

Also widely used is the method of printing on barcodes, or point codes, or similar detection characteristics which can be read via suitable sensor devices into the further processing equipment. More or less extensive amounts of data can thus be transmitted further. This method is frequently used for the product identification, for example for the purpose of order data allocation or for personalized products. The advantage is again the relatively easy application. The necessity of affixing additional marks, however, is a disadvantage since the position of a barcode in most cases cannot be used for precise adjustments (e.g. for the cross cutter).

Also known are applications where the printing system transmits information via data communication to the further processing equipment. For example, this is achieved in concrete terms with the aid of a UP31 protocol. This solution has the advantage of a nearly unlimited amount of data which can thus be transmitted further, but also has the disadvantage that it is difficult to allocate the datagrams to a physical paper position. In most case, this takes place via theoretically conveyed paper lengths, but frequently requires additional barcodes or marks.

In summary, we can state that all the aforementioned methods can be used to transmit more or less data from the printing system to the further processing equipment. The data for the most part relate to the product flow (signature number, order characterization) or serve as a trigger for the operational control (cross cutter; deflector systems, selective feeding). All printed-on information is chronologically fixed to the point in time before the printing. The known datagram solutions replace or supplement in the same way the printed-on information.

Information is furthermore accumulated in the printing system which cannot be transmitted via barcodes transmitted in advance, e.g. the marking of the last printed sheet of an order. The imposition of the printed sheet always relates to a copy of the product which is then printed repetitively in an optional number. Thus, the last copy of an order cannot contain a different barcode. This could only be realized with a barcode affixed in real time, within the context of the raster process, which is tied to high expenditure and would result in posing high requirements for the data management of the printing system.

### SUMMARY

Various embodiments are generally directed to a method for detecting and transmitting process-control data before and/or during a printing operation for the production of printed products in a printing press to overcome the aforementioned problems.

One or more embodiments may include a method for detecting and transmitting process-control data before and/or during a printing process for producing printed products in a printing press, the method comprising: detecting process-control data from detection characteristics that are effectively connected to at least one printed product; transmitting and/or transferring data resulting from the detection characteristics to at least one processing unit arranged downstream of a location of the printing process; detecting product-related data within the printing process; and using the product-related data for at least one redundant check of the data obtained from the detection characteristics.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts an exemplary process flow diagram 100 in accordance with one or more embodiments.

FIG. 2 depicts an exemplary print system 200 in accordance with one or more embodiments.

FIG. 3 depicts a generic datagram format 300 in accordance with one or more embodiments.

FIG. 4 depicts an exemplary datagram 400 in accordance with one or more embodiments.

### DETAILED DESCRIPTION OF THE DRAWINGS

This disclosure provides a number of system-immanent measures which ensure a real time transmission and/or transfer of information in connection with a printing process, which information then guarantees the further processing of the printed products which is determined ahead of time.

According to this disclosure, the printing system is thus provided with information relating to the internal operations during the production and further processing of printed products. In particular, the stop positions are precisely known and the printing system is constantly informed of which printed sheets were printed completely or not completely. Further process-control information is also known or can be procured directly. The idea behind the disclosure is aimed at making available these data, which are present in the printing system, to the further processing equipment in a timely and materially applicable manner.

For this purpose, a method is proposed for detecting and transmitting process-control data before and/or during a printing process for producing printed products in a printing press, preferably a digital printing press, wherein these data are detected at least with the aid of characteristics, effectively connected to a printed product, henceforth called a print mark, wherein the data obtained from the print mark are transmitted and/or transferred to at least one processing unit that is arranged downstream of the printing operation. During the integral printing process, a first detection of data is carried out, which data are then used for at least one redundant check of the data obtained from the print mark.

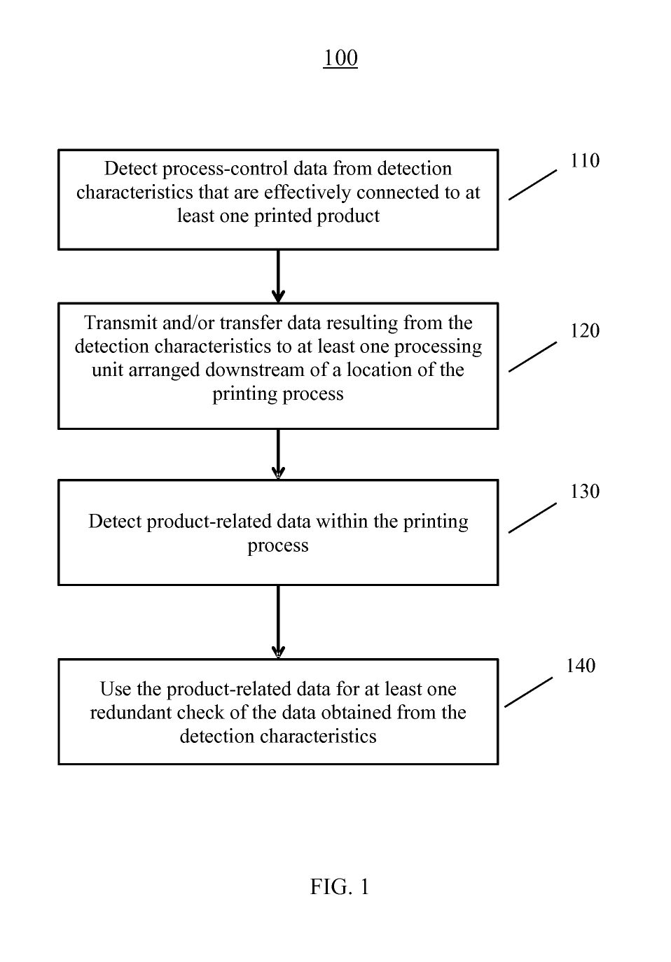

FIG. 1 depicts an exemplary process flow diagram 100 in accordance with one or more embodiments. In block 110, process-control data from detection characteristics that are effectively connected to at least one printed product may be detected. In block 120, data resulting from the detection characteristics may be transmitted and/or transferred to at least one processing unit arranged downstream of a location of the printing process. In block 130, product-related data within the printing process may be detected. In block 140, the product-related data may be used for at least one redundant check of the data obtained from the detection characteristics.

It should be taken into consideration that a print mark of this type, which is preferably based on a codification, belongs to at least one printed product. This print mark, which is intended to contain product-related data, ensures that information is available which is absolutely necessary for the further processing of the printed products.

Print marks containing product-related data comprise, among other things, information relating to the control of a cross-cutter, based on the cutting marks, or on the book separation based on the separating marks. Of course, print marks can also contain other product-related data.

According to the disclosure, at least one redundant check of the product-related data obtained from the print mark is thus realized during the printing process, with the goal of determining to what degree these data coincide with the effective data acquired during the printing process.

According to the disclosure, a redundant check is first carried out, bearing in mind that product-related interferences can occur before or during the printing process which no longer can be acquired or reflected by the print mark.

Without realizing such a check, the imminent danger always exists that incorrect conclusions are reached during the further processing of the printed products since the data obtained from the print mark no longer coincide with or differ to some degree from the effective condition of the printed product.

It should furthermore be taken into consideration that when detecting differences in points, these can also be values which do not necessarily trigger a process-oriented consequence, but can belong to the so-called soft factors because of their low place value and do not necessarily have to be considered for the further production course. For example, the non-confirmation of a purely informative and secondary coding which does not directly influence the production process of the printed products does not result in consequences for the further course of the printing operation. If need be, the determination can be subjected to a new weighting at a later point in time, meaning the system is designed for flexibility.

The data acquisition during the printing process, however, is not restricted simply to the redundant check of the data obtained from the print mark. At the same time, additional quality-related data for the printed product are detected during the printing process which have not been or have not yet been acquired by the print mark, but which may have a high relevance for the further processing of the printed products.

Accordingly, one can say that during the printing process an integral check of the printed products takes place with respect to the product-related data and the fixed quality-related data, which data are then made available to the equipment for the further processing of the printed products before they are realized during the processing.

In the normal case, the print mark is attached along a working track (see also EP2481585 A1), wherein the print mark remains visually observable in that case. However, non-visually observable codifications can also be used which need not be affixed along the working track. In those cases, the individual printed sheets can also be provided directly with the codifications, wherein this considerably facilitates the allocation during the processing.

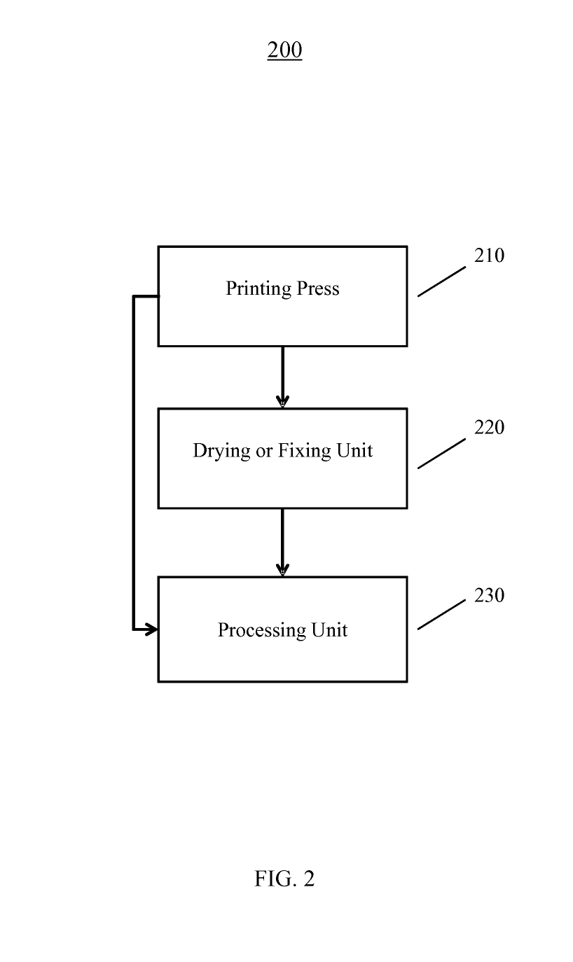

FIG. 2 depicts an exemplary print system 200 in accordance with one or more embodiments. Datagrams are transmitted from the printing press 210 to the further processing location with the aid of a suitable communication system, for example the Ethernet UDP/IP. The point in time for transmitting is defined as point in time X which follows immediately after the completion of the printing operation and is defined by the existence of the required information.

Typically, the point in time for the transmission is set to a time after the printed products have passed through the drying or fixing unit 220, wherein some information can already be acquired and transmitted further during the printing process, before passing through these units. At least the aforementioned units, meaning the drying or fixing unit, form an integrated component of the printing process.

During the exit of the printed products from the printing process, the printing press can provide a final statement concerning the correctness of the product-related data obtained from the print mark on the basis of the redundant check. As a result of detecting the quality-related data of the printed product and/or the printed sheet during the printing process, a total amount of information is made available for the further processing. Complementary information, which can be detected from case-to-case and which is connected to the redundant check of the print mark as well as the remaining data detected during the printing process, is thus also available at the end of the printing process.

The allocation of datagrams to a specific physical printed sheet represents one key aspect of the transmission and/or transfer of data to the further processing equipment. To simplify the implementation on the side of the printing system, only a few corner data are specified:
The datagrams can be sent only if the data are available.
The latest point in time for sending the datagrams must ensure that these arrive at the further processing location before the arrival of the respective printed sheet.
The sequence of the datagrams should always be maintained. In individual cases, however, the datagrams can behave differently toward each other.
Precisely one datagram exists for each printed sheet. Multiple datagrams for the same printed sheet are not permissible.

These marginal transmitting conditions, initially specified in order to optimize the “expenditure/yield,” can be supplemented as needed during the further processing of the printed products with the aid of additional order data and signature data, wherein a synchronizing or reconciling occurs in that case, based on the total amount of existing data. In particular, the synchronizing of data always occurs in cases where the allocation of a printed sheet is difficult on the side of the further processing operation, thus making it possible to secure the sequence allocation and the order allocation. In addition, a copy counter can also be used for referencing a specific copy within an order for a number of identical copies. During the transmission and/or transfer of data obtained during the printing process, the question arises which rank can be occupied by the different information used for the further processing. Information that differs should mostly be expected if the original data and the newly obtained data of the print mark do not match, following the redundant check of the data. However, it can happen that even with newly determined data from the printing process that these data contradict the previously collected information, for example as is the case with quality-related data.

In those cases it is important to define the operative rank of the data in general, so that sending multiple datagrams for the same printed sheet can absolutely be avoided.

A first option consists of allocating the absolutely highest rank to the latest data obtained during the printing process, as compared to the product-related data from the print mark. Normally, this also applies for the quality-related data which, according to the disclosure, are collected separate from the redundant check during the printing process.

However, we can imagine cases where a certain differentiation is useful, for example if the quality-related data occupy an absolute rank only for specific printed products or situations.

Even if the redundant check of the data obtained from the print mark did not lead to a different conclusion during the printing process, the quality-related data can still trigger a gradual substitution or error correction, as compared to the product-related data, wherein the degree of such an implementation can be different from case to case.

It is also possible that certain quality-related data should only occupy a lower-rank operative allocation, for example in cases where divergence occurs between the original data obtained from the print mark and the data obtained during the printing process.

The synchronizing check of the quality-related data can thus result in determined differences which are considered soft factors because of their low place value and do not require taking an immediate measure during the operative process. For example, quality-related functions or determinations are conceivable which are determined to be not provided and/or existing during a first check. However, the system itself may determine at a later time just how accurate or not accurate the previous determination was, meaning the system is designed for flexibility.

As previously stated in the above, for data transmitted and/or transferred based on an operative rank allocation, the precept always applies that these data must in all cases be supplied ahead of time to a processing unit 230, before the arrival of the printed product or printed sheet.

As signaled in the above, the transmission of the data packets supplied to the further processing location can be revised, wherein the normally used sequential transmission and/or transfer can change as needed to a partially sequential one, wherein even an overlapping is not excluded, but always under the premise that the information arriving at the further processing location is unambiguous. Whether or not a revision of the data relative to each other should take place is determined case-by-case.

The system provides that a defective printed product, detected based on at least one information bit, is removed immediately or is transferred out later on. If the first product that is removed is a printed sheet or signature, all following printed sheets are also removed continuously which, together with the removed printed sheet, form a partial product, a partial book block, or a book block. The continuous supply of the partial product or finished product, not completed prior to the start of the removal operation, is restarted when a subsequent delivery of the removed printed sheet is secured.

The essential advantages of the disclosure must be seen in that:

With the aid of the status formed with the totality of the transmitted data, the processing units designed for the further processing are enabled to recognize whether the arriving printed sheets possess all necessary characteristics which are absolutely required for the processing to a final product. All stop, interference and emergency stop situations can thus be solved fully automatically and with high reliability.

Special maintenance and start-up print patterns can be distinguished reliably from good signatures with the aid of an operation mode and, accordingly, can be conveyed out. In addition, this information allows inserting specific quality patterns into a printing order and to move these printed sheets to a special delivery location. As a result, quality assurance measures can be provided for the client side.

The “end-of-job-information” permits a reliable detection of the last printed sheet of an order. With this information, the empty cycle or the changeover to a different order can be started at the precise position, which is essential in particular for the “multi-job-production.”

### Exemplary Embodiments

The seamless integration of a digital printing press into the applicant's “SigmaLine” is disclosed in European Patent document EP 1288015 A1 and in U.S. Patent Application Publication No. 2003/0044260, the contents of each of which is hereby incorporated herein by reference in its entirety, results in an essential market advantage for the “Book-on-Demand” solution. Owing to this integration, it is possible to offer a continuous work flow starting with the pre-printing stage, via the digital printing operation, on to the inline further processing operation. A number of steps make it possible to ensure a product-related tracking with quality assurance measures and comfort functions, such as automatic reprints, based on a single job ticket.

One essential and unique feature of the applicant's aforementioned “Book-on-Demand” solution is that it allows a tight integration of the digital printing press into the process. It is only thanks to this integration that the solution can ensure very short conversion times between different orders.

The duplications in the area of order preparation, known from the BoD

(Book-on-Demand) systems do not exist with the above-referenced “SigmaLine.” The machine operator prepares the order at the central control unit and then transmits this order via mouse click simultaneously to the digital printing press and the further processing equipment.

All components use the same database and are optimally adapted to each other. Faulty inputs and misunderstandings, such as occur during the manual transmission of data between the components, are in principle not possible with the “SigmaLine.” A central element of these concepts is the timely transmission of data from the printing press to the subsequent further processing equipment, wherein these data contain information on the quality of the printed pages and ensure a precise product tracking of the copies.

The following is an excerpt from the specification for the “Sig Events,” also known as “SIG EVENTS.” It shows the criteria used for the composition and content of the datagrams.

### Datagram Specification:

The following represents an excerpt from the specification for the SIG EVENTS, illustrating the composition and content of the datagrams.

A “SIG EVENTS” datagram is a character string composed of ASCII characters. The datagram starts with a curved bracket ‘{’ and ends with such a bracket ‘}’.

The values are separated by double dots.

Numerical values are inserted in the form of a character string.

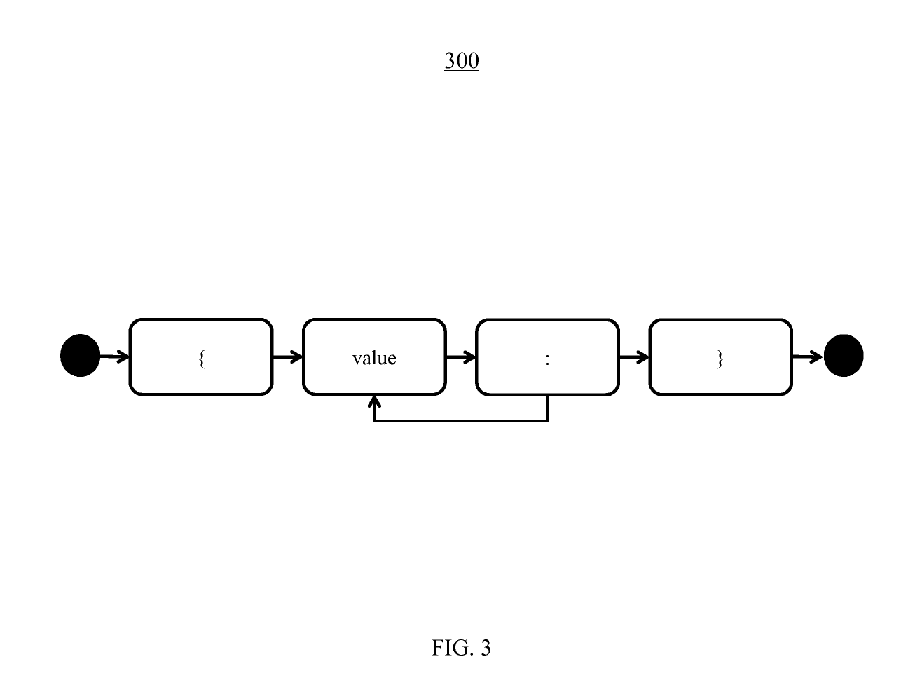

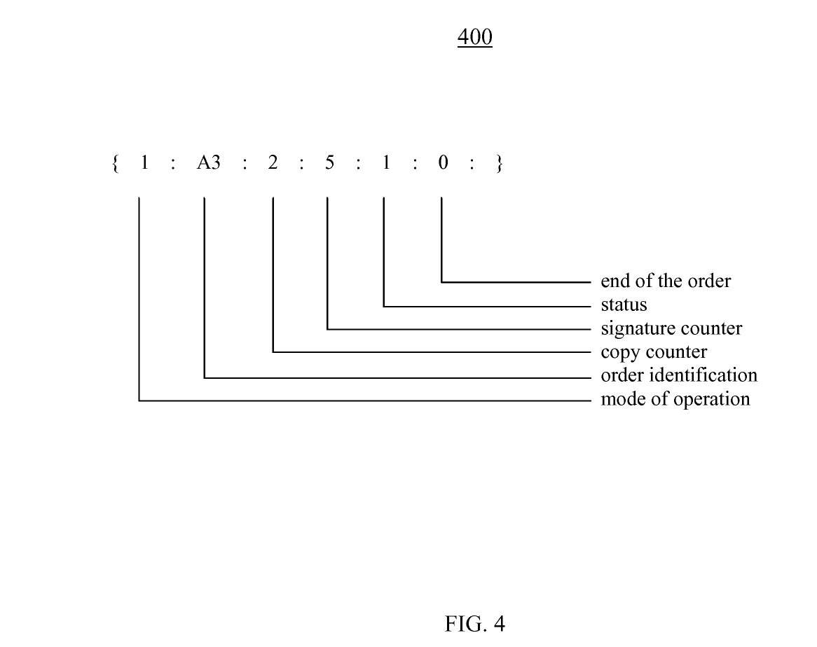

FIG. 3 depicts a generic datagram format 300 in accordance with one or more embodiments. FIG. 4 depicts an exemplary datagram 400 in accordance with one or more embodiments.

TABLE 1

| posi- | | | | |
|---|---|---|---|---|
| tion | attribute | range | value | importance |
| 1 | mode of | 0 . . . 255 | 0 | unprinted paper, waste paper |
| | operation | | | (optional) |
| | | | 1 | printed paper (standard value) |
| | | | 2 | print pattern, test pattern, etc. |
| | | | | (optional) |
| | | | 3 | quality print pattern (optional) |
| 2 | order | 1 . . . 62 | test/ | attribute JobID from the JDF |
| | identifi- | | UTF-8 | order ticket |
| | cation | | | |
| 3 | copy | 0 . . . 2³²-1 | 0 | unprinted or poorly printed |
| | counter | | | paper |
| | | | 1 . . . | incrementing counter for each |
| | | | max | product copy; only incre- |
| | | | | mented in the operating mode |
| | | | | 1 |
| 4 | signature | 0 . . . 2³²-1 | 0 | unprinted paper, waste paper, |
| | counter | | | print pattern, test pattern, etc. |
| | | | 1 . . . | incrementing counter for each |
| | | | max | signature; only incremented in |
| | | | | operating mode 1 |
| 5 | status | 0 . . . 255 | 0 | poor; will be removed |
| | | | 1 | good; used for the production |
| 6 | end of | 0 . . . 255 | 0 | an optional signature within |
| | the order | | | an order |
| | | | 1 | last signature of the last copy |
| | | | | of an order or last good |
| | | | | printed signature in the case |
| | | | | of an order stop. |

1. A method for detecting and transmitting process-control data before and/or during a printing process for producing printed products in a printing press, the method comprising:
detecting process-control data from detection characteristics that are effectively connected to at least one printed product;
transmitting and/or transferring data resulting from the detection characteristics to at least one processing unit arranged downstream of a location of the printing process;
detecting product-related data within the printing process; and
using the product-related data for at least one redundant check of the data obtained from the detection characteristics.

2. The method according to claim 1, wherein the detecting includes acquiring characteristics with the aid of a print mark.

3. The method according to claim 1, wherein the detection characteristics are designed for the detection of product-related data.

4. The method according to claim 1 further comprising:
following the redundant check, synchronizing or reconciling the product-related data detected during the printing process with the data obtained from the detection characteristics; and
then transmitting and/or transferring the product related data to at least one further processing station for the printed products which is specified ahead of time.

5. The method according to claim 1, wherein the redundant check of the determined product-related data distinguishes between absolute requirements and soft requirements, that if any differences are detected for the absolute requirements, process-oriented measures are taken and that if differences are detected with respect to the soft requirements, flexible process-oriented measures are taken.

6. The method according to claim 1, wherein during the printing process a different determination of data takes place which detects quality-related data for the printed products, wherein the quality-related data relate to the printing process.

7. The method according to claim 6 further comprising:
once the quality-related data are detected, transmitting and/or transferring the quality-related data individually or synchronized with the product-related data to at least one further processing station for printed products which is specified ahead of time.

8. The method according to claim 6, wherein the quality-related check of the determined data distinguishes between absolutely required and soft characteristics, that if differences are detected for the absolutely required characteristics, process-oriented measures are taken and if differences are detected for the soft characteristics, flexible process-oriented measures are taken.

9. The method according to claim 1 further comprising:
completing the printing process once the printed products leave the drying and/or fixing units belonging to the printing process.

10. The method according to claim 1, wherein the detection characteristics are based on a codified print mark for which the code elements can at least be one of visually detected or not visually detected.

11. The method according to claim 1 further comprising:
affixing detection characteristics to a working track along a paper roll or within a printed product or printed sheet.

12. The method according to claim 6 further comprising:
allocating the quality-related data which are determined during the printing process an absolutely predominant or quasi-predominant operative rank, as compared to the data obtained from the detection characteristics or the data resulting from the redundant check.

13. The method according to claim 6 further comprising:
allocating the quality-related data which are determined during the printing process a substitutive or partially substitutive operative rank, as compared to the data obtained from the detection characteristics or the data resulting from the redundant check.

14. The method according to claim 6 further comprising:
allocating the quality-related data which are determined during the printing process a secondary operative rank, as compared to the data obtained from the detection characteristics or the data obtained from the redundant check.

15. The method according to claim 6 further comprising:
transmitting and/or transferring the product-related and/or the quality-related data ahead of the respective printed product or printed sheet to a processing unit.

16. The method according to claim 6 further comprising:
removing, following the printing process, a defective printed product or printed sheet which is detected based on the product-specific and/or quality-related data immediately following the printing process or subsequent thereto.

17. The method according to claim 16 further comprising:
removing, along with removing the defective printed product or the printed sheet, all following printed products or printed sheets which form a unit or a book block together with the defective printed product or printed sheet that is removed are also removed.

18. The method according to claim 16 further comprising:
starting up again a continuous supply of an end product or an intermediate product, which has remained incomplete because of the removal of the defective printed product or printed sheet, with the arrival of subsequently delivered printed products or printed sheets, which are designed to replace the removed defective printed sheets or printed products.

19. The method according to claim 7 further comprising:
supplying the determined data sequentially, quasi-sequentially, overlapping and ahead of time to the further processing location.

20. The method according to claim 1 further comprising:
transmitting the data according to a User Datagram Protocol/Internet Protocol (UDP/IP) system.

21. The method according to claim 1 further comprising:
transmitting the data on the basis of a SIG Events specification.

22. The method according to claim 1, wherein the printing press is a digital printing press.
